(19) United States
(12) Patent Application Publication
(10) Pub. No.: US 2005/0166235 A1
(43) Pub. Date: Jul. 28, 2005

(54) Setting all channels in a television channel viewing list to a block or view state

(75) Inventors: Mark Gilmore Mears, Zionsville, IN (US); Khelan Maheshchandra Modi, Indianapolis, IN (US)

Correspondence Address: THOMSON LICENSING INC., PATENT OPERATIONS, PO BOX 5312, PRINCETON, NJ, 08543-5312, US

(73) Assignee: Thomson Licensing S.A., F-92100 Boulogne-Billancourt (FR)

(21) Appl. No.: 10/512,367

(22) PCT Filed: Apr. 10, 2003
(86) PCT No.: PCT/US03/11092

Related U.S. Application Data
(60) Provisional application No. 60/374,888, filed on Apr. 23, 2002.

(51) Int. Cl. H04N 5/445; G06F 13/00; G06F 3/00

(52) U.S. Cl. 725/47; 725/44

(57) ABSTRACT

A system, apparatus and/or method including or embodied as a television signal processor provides a user setting up a channel surf list or parental control list with the option of blocking (prohibit viewing) or unblocking (allow viewing) all available channels at once. This serves as a convenient starting point to save time before editing the channel list since if the user expects that most of the channels are to be blocked, one can start out by blocking all of the channels, then make some of the channels unblocked (i.e. viewable) and/or vice versa. In one form, separate channel surf or parental control lists pertaining to separate television signal inputs are maintained with each list provided with the global viewing status or state setting option.

This U.S. non-provisional patent application claims the benefit of and/or priority to U.S. provisional patent application Ser. No. 60/374,888 filed Apr. 23, 2002 entitled “Setting All Channels to Block or View State for Parental Control” both of which are commonly assigned.

### BACKGROUND

1. Field of the Invention

The present invention concerns television signal processing and, more particularly, concerns a system, method and/or apparatus for setting up a television channel viewing list.

2. Background Information

Televisions of today are able to receive a multitude of television channels that provide a vast variety of television programming. Such television programming runs the gamut from news channels, sports channels, science channels, documentary channels, movie channels, adult entertainment channels, variety channels, music channels and other types of programming channels. Because of the great number of television channels that are available, not every user is desirous of viewing each and every channel. Consequently, televisions now allow a user to individually de-select a particular television channel from what may be known as a “surf” list. A surf list constitutes those television channels that are tuned to when the user presses the channel up (i.e. channel +) and/or the channel down (i.e. channel −) buttons or keys on a remote control device (i.e. remote).

In accordance with Federal Communications Commission (FCC) mandate, televisions sold in the United States are now required to implement what is known as the V-chip parental control system (i.e. V-chip or V-chip standard). The V-chip standard provides a user (e.g. parent) control of whether particular programming is viewable or blocked. The V-chip control screens required by the FCC must provide for hierarchical control. That is, when blocking a “low” rating (e.g. TV-PG), all ratings above it are automatically blocked (e.g. TV-14, TV-MA), although the user can then edit the higher ratings and their associated rating content levels (e.g. dialog, language, sex, violence, fantasy violence) to be unblocked if so desired. This may be termed a parental control list or V-chip list.

In order to set up a channel viewing list (either a “surf” list or a “parental control” list), one must go to a control menu of available channels and individually highlight or click on a “blocked” or “viewable” button associated with every channel. Thus, when setting up a channel viewing list, it is tedious and time-consuming for the user to have to click on every blocked/viewable “flip-flop” (toggle) button for every channel in order to get the particular channel into the viewing state he/she desires.

It is evident from the above that there is a need for allowing a user to more easily set up a television channel viewing list.

### SUMMARY OF THE INVENTION

A system, apparatus and/or method including or embodied as a television signal processing apparatus provides a user setting up a channel surf list or parental control list with the option of blocking (prohibit viewing) or unblocking (allow viewing) all available channels at once.

In one form, there is provided a method of setting up a television channel viewing list in a television signal processing apparatus comprising (a) receiving user selection of a viewing state with regard to a television channel viewing list having a plurality of available television channels; and (b) setting each television channel of the plurality of available television channels in the television channel viewing list to the user selected viewing state.

### BRIEF DESCRIPTION OF THE DRAWINGS

In the drawings:

FIG. 1 is a block diagram representation of a television system incorporating a television signal processing apparatus in accordance with the principles of the subject invention;

FIG. 2 is a block diagram of an exemplary television signal processing apparatus in accordance with the principles of the subject invention;

FIG. 3A is a representation of an on-screen display of an exemplary channel viewing status list in accordance with the principles of the subject invention in an initial set-up mode;

FIG. 3B is a representation of the on-screen display of FIG. 3A showing the exemplary channel viewing status list in accordance with the principles of the subject invention in an after set-up mode;

FIG. 4A is a representation of an exemplary high definition television system having multiple source inputs and parental control allowing source selection and multiple viewing lists according to the various source inputs depicting an on-screen display of a source selection menu;

FIG. 4B is a representation of the high definition television system of FIG. 4A in which a source selection has been made showing a Locked and Unlocked viewing list on-screen display; and

FIG. 5 is a flowchart of an exemplary manner of operation of the subject invention.

Corresponding reference characters indicate corresponding parts throughout the several views.

### DESCRIPTION OF THE PREFERRED EMBODIMENT(S)

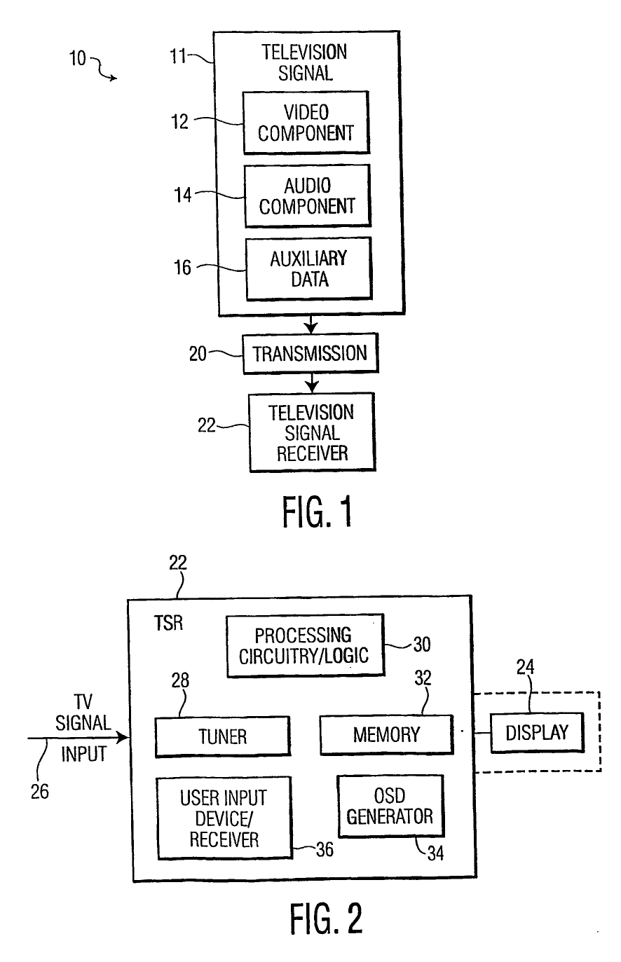

Referring now to FIG. 1, there is depicted a block diagram of a television signal system generally designated 10. The television signal system 10 includes a television signal generally designated 11. The television signal 11 is representative of an analog television signal and/or a digital television signal. Moreover, the television signal 11 represents one or more television channels. In the below discussion, the television signal 11 will be assumed to be a single television channel, although as in the case of a digital television signal, multiple television channels may be carried thereby.

The television signal 11 has a video component 12 that carries video information or data for the television channel. The form of the video information or data may be of any scheme (i.e., analog or digital and, if digital, encoded in any of various formats). An audio component 14 of the television signal 11 carries audio information or data for the television channel. Again, the form of the audio information or data may be of any scheme.

The television signal 11 may also carry auxiliary data or information 16. The form of the auxiliary data depends on whether the television signal 11 is an analog or digital television signal. In the case of an analog television signal, the auxiliary data may comprise data carried in the vertical blanking interval (VBI) and/or extended data service (XDS) information such as is known in the art. This information includes, but is not limited to, closed caption data, teletext data, V-chip data (i.e. parental control or rating data for the particular television program being carried by the television signal) and/or other information. In the case of a digital television signal, the auxiliary data may comprise PSIP (Program and System Information Protocol) information or data. The PSIP information includes what is known as an off-air guide. The off-air guide includes virtual channel number, program title and other information that are used to display various information regarding a given program and channel. The PSIP data also includes (within the off-air guide or not) rating information for parental control.

The television signal 11 is then transmitted, as represented by the transmission box 20, to television signal processing apparatus represented in FIG. 1 as television signal receiver (TSR) 22. Transmission 20 includes transmission over the air, via satellite, cable system and/or the like. Transmission 20 also includes re-transmission, including any manner in which the television signal 11 is distributed to the television signal receiver 22.

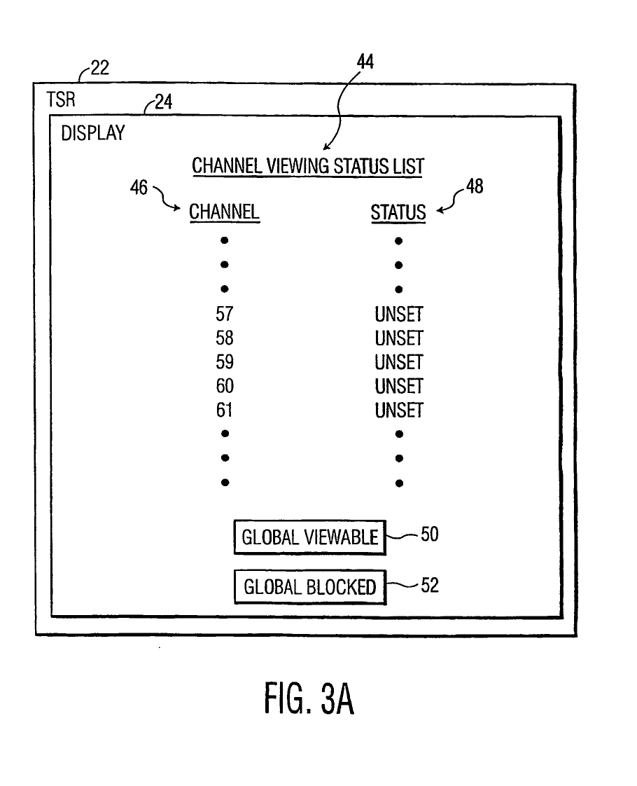

Referring now to FIG. 2, there is depicted a block diagram of exemplary television signal processing apparatus or system corresponding to television signal receiver 22 in accordance with the principles of the subject invention. The television signal receiver 22 may or may not include an integral display 24 as represented by the dashed lines. In the case that the television signal receiver 22 does not include an integral display, the television signal receiver 22 produces a signal suitable for producing a displayed image and is connectable to a display 24. In both cases the display 24 is adapted, configured and/or operative to provide on-screen display of information such as set-up menus, status lists such as a channel viewing status list (a surf list and/or a parental control list) or the like, preference selection and/or status lists, and/or the like, some of which are described herein in connection with the principles of the present invention and some of which are known in the art. The television signal receiver 22 may therefore be embodied as, for example, a television (having an integral display), a set-top box (not including a display and producing a signal suitable for connection to a separate display), or the like.

The television signal receiver 22 has an input 26 that is adapted, configured and/or operative to be connected to and thus receive a plurality of television signals 11 (e.g. digital television (DTV) transport streams (TS) or signals and analog television channels/signals). A tuner 28 is provided that is adapted, configured and/or operative to receive and tune a particular television channel. Note that while the embodiment shown in FIG. 2 includes tuner 28 within TSR 22, other embodiments of television signal processing apparatus incorporating principles of the invention may not include a tuner. For example, a tuner may be a separate unit coupled to a television signal processing system or apparatus incorporating other features of the system shown in FIG. 2.

The television signal receiver 22 further includes a signal processor 30, e.g., processing circuitry/logic, processor, processing means, or the like. In the exemplary embodiment described herein, signal processor 30 is depicted as a single block comprising television processing circuitry/logic that may be embodied as one or more integrated circuits (ICs) with or without additional circuitry/logic. The television processing circuitry/logic 30 is adapted, configured and/or operative to process analog and/or digital television signals, as the case may be, in order to obtain the audio component 14 for sound reproduction, the video component 12 for display, and obtain the auxiliary information 16. The television processing circuitry/logic 30 is further adapted, configured and/or operative to perform other television signal receiver tasks such as are typical and/or known in the art and to generally control, regulate and/or operate the components of the television signal receiver 22. To this end, the television processing circuitry/logic 30 is adapted, configured and/or operative to utilize programming (software), program instructions and/or the like that are stored in a memory 32. The program instructions may be written in any language that is, of course, compatible with the television signal receiver 22.

Moreover, the television signal receiver 22 includes an on-screen display (OSD) generator 34 that is adapted, configured and/or operative to generate, under control of the processing circuitry/logic 30 and/or program instructions stored in the memory 32, on-screen display signals the allow the display 24 to depict or show various text messages, menus, lists and/or the like with or without various graphics with or without selectable features. Such selectable features may include highlighted choices that change state from one choice to another, buttons that toggle or flip-flop choices, or the like. In one exemplary instance, and discussed further below, the on-screen display generator 34 provides on-screen display of a channel viewing list menu showing the television channels that are available for viewing (from a particular input), and user-selectable preferences associated therewith (i.e. viewable or blocked).

Still further, the television signal receiver 22 includes a user input device and/or receiver 36. The user input device/receiver 36 is adapted, configured and/or operable to accept or receive input from a user regarding an aspect, feature and/or preference with regard to the television signal receiver 22. In one form, the user input device/receiver 36 may be a remote control (not shown) and associated remote control receiver such as an IR transmitter/receiver. In another form, the user input device/receiver 36 may be a panel of buttons or the like that allow user input. User input is accepted by the television signal receiver 22 for various purposes such as in response to function and/or feature choices provided as on-screen menu choices and/or options. In accordance with the principles of the subject invention, the user input device/receiver allows the input and receipt of a viewing state or status choice or selection usually in response to a menu such as that described herein. In accordance with an aspect of the present invention (and explained further below), the user input device/receiver also allows the user to choose a global viewing status or state that is applied to all of the available television channels (i.e. allowing the user to choose either viewable or blocked the choice of which is applied to every one of the available television channels), and as well thereafter individually change (toggle or flip-flop) the viewing status for a particular television channel.

It should be appreciated that the television signal receiver 22 also includes other components not particularly shown and/or described herein that are typical of digital television signal receivers. Moreover, the television signal receiver 22 is capable of many features and/or functions typical of current television signal receivers.

The television signal receiver 22 stores program instructions in the memory 32 which are executable by the processing circuitry/logic 30 for operation of the television signal receiver 22. The program instructions also provide for the viewing and/or blocking of, a particular television channel or channels, as well as the maintaining of a channel viewing list or lists with respect to a particular television channel input when there are multiple television inputs or sources (e.g. satellite, cable, antenna A, antenna B, etc.). This is generally known as a channel viewing list, however, this feature may also be known as V-chip list, parental control list, channel viewing status or state, or otherwise. While the television signal receiver 22 includes the ability to lock or otherwise control access (set-up and/or changing the settings thereof) to this feature, function and/or ability. The television signal receiver also may provide for the temporary viewing of a blocked channel based on an inputted code, personal identification number (PIN), or the like. This is accomplished in a manner known in the art.

In accordance with the principles of the subject invention, the program instructions allow for a television channel viewing list to be set up with all of the available television channels settable into either a blocked or viewable status or state. When a television channel is set to a viewable state, the television channel will be heard and seen when a channel up or a channel down command is received, as well as the direct input of the television channel number as via a numeric keypad or the like. When a television channel is set to a blocked state, the television channel will not be heard or seen when a channel up or a channel down command is received, as well as the direct input of the television channel number as via a numeric keypad or the like. The television channel list is editable for each television channel individually (i.e. each television channel may be initially set to either blocked or viewable, as well as being changed from one state to another). Additionally, in accordance with the principles of the subject invention, the television channel list accepts a global status or state selection of viewable or blocked that is applied to all of the channels at once. Thus, if the user thinks that most of the television channels will be viewable, then the global viewable choice is selected and each television channel is set to viewable. The user may thereafter individually block those channels he/she does not want to be viewed. Similarly, if the user thinks that most of the television channels will be blocked, then the global blocked choice is selected and each television channel is set to blocked. The user may thereafter individually set those channels to viewable he/she wants to view. The channel viewing list allows global state change at any time even after a previous global state change.

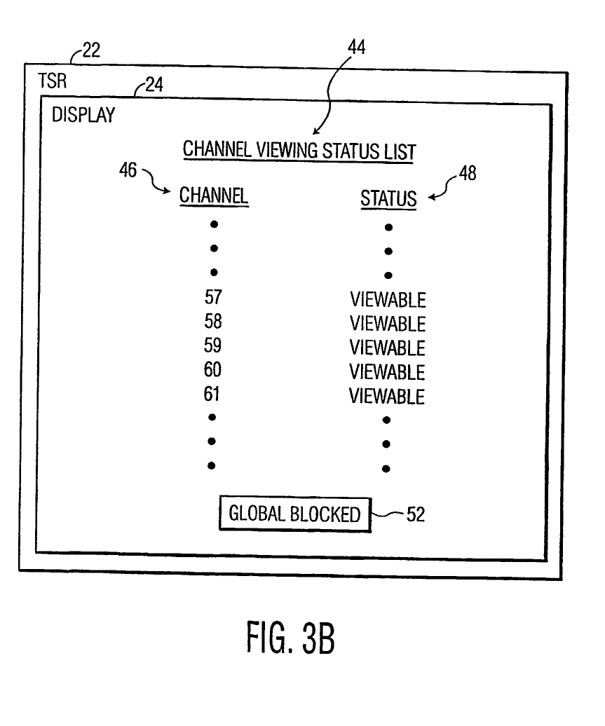

With reference to FIG. 3A, an exemplary on-screen display of a channel viewing status list or menu 44 is shown in which one manner of the above principles may be implemented. Particularly, the channel viewing status list 44 provides a viewing status or state list of the available television channels and allows the global setting of all of the television channels to one viewing state, that viewing state being either viewable or blocked. The channel viewing status list 44 may also provide for the setting of a viewing state for an individual television channel especially after the viewing list status or state has been globally set per the present principles. Stated in other terms, the television signal receiver 22 allows for the setting and/or changing of the viewing status or state of a particular television channel 46 by the user, e.g., a parent, and the global setting of all available channels to a particular viewing status or state via a single menu selection or choice.

The channel viewing status list 44 is provided to the display 24 via the on-screen display generator 34. The channel viewing status list 44 shows the available television channels 46 in a scrolling menu fashion, and the current viewing status 48 associated with a particular television channel 46. The television channel 46 may be analog or digital. In FIG., 3A, the channel viewing status list 44 is shown before any viewing status has been assigned, that is, upon initial set-up of viewing status. As such, the viewing status or state 48 is shown as “Unset.” Of course, other designations or no designation may be used.

The channel viewing status list 44 also includes a global viewable button or selection 50 selectable by the user in a manner conventional for television menu choices, and a global blocked button or selection 52 again selectable by the user in a manner conventional for television menu choices. Of course, other manners of providing such global viewing states may be used. Selection of the global viewable button 50 sets all of the television channels 46 to viewable, while selection of the global blocked button 52 sets all of the television channels 46 to blocked.

Referring to FIG. 3B, there is shown the channel viewing status list 44 after user selection of a global status button 50, 52. In this example, the user has selected the global viewable button 50. The viewing state or status 48 of each television channel 48 is therefore set to viewable. This is shown in the status column 48. The user is now able to individually highlight and change the viewing status for each television channel (in this example to blocked) if desired. Additionally, only the global blocked button 52 is shown since viewable was selected, however, both global buttons may be shown should the user, after individually changing the viewing state of some of the television channels, change his/her mind, they can again be set to the viewable state. Of course, the same procedure is used should the user initially select the global blocked button 52.

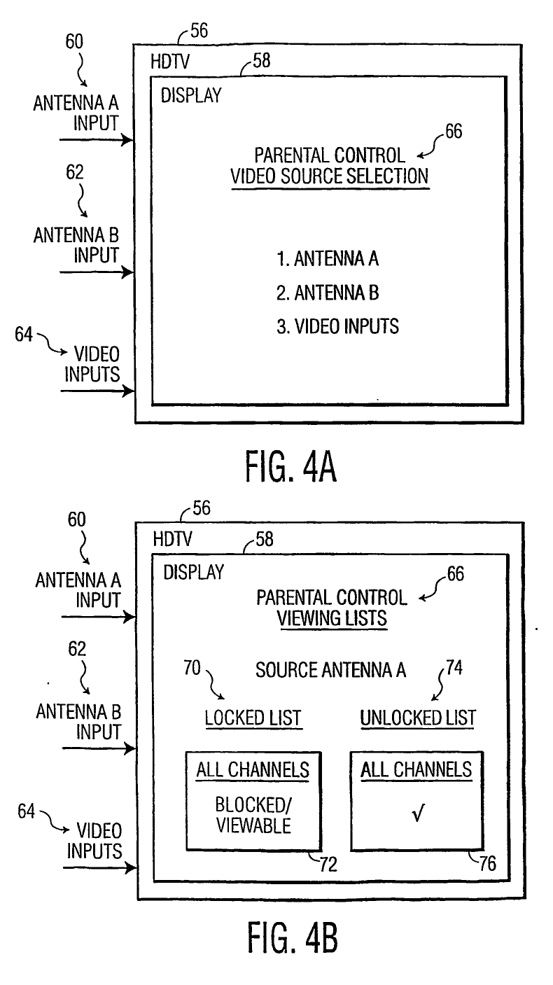

Referring now to FIG. 4A, there is depicted a representation of an exemplary high definition television (HDTV) in which another manner of the principles of the subject invention may be performed. Particularly, there is depicted an HDTV 56 having (or connected to) a display 58 in the same manner as the television signal receiver 22 is to the display 24. The HDTV 56 has multiple television signal inputs. Particularly, the HDTV 56 has a first television signal input 60, designated Antenna A to which is connected a first antenna, a second television signal input 62, designated Antenna B to which is connected a second antenna, and a third television signal input 64, designated Video to which is connected one or more video sources. The HDTV 56 allows the selection of television signal inputs to view and, in accordance with an aspect of the subject invention, provides a separate television channel viewing state lists for each television signal input. It should be understood that in the present example, the television channel viewing state or status list is provided under a parental control aspect or feature.

The display 48, through the on-screen generator 34, provides a parental control video source selection menu 66. The three television signal inputs (i.e. Antenna A, Antenna B, and Video) are selectable by the user. Each one of the television signal inputs has a “Locked List” (blocked viewing state list) and an “Unlocked List” (viewable viewing state list). The Locked List is enforced when the television is locked, that is, when the user tunes to a channel marked as “Blocked” in the Locked List, the user must first provide a password or personal identification number (PIN) before the video or video and audio will be viewable or viewable and hearable. The Unlocked List is in effect when the TV is unlocked, that is it can comprise the user's favorite channels. In order to set up the Locked and Unlocked Lists, the user goes to the Parental Control menu 66 and selects the video source to be set up (e.g. Antenna A).

Referring now to FIG. 4B, the display 58 of the HDTV 56 now shows a Locked List 70 and an Unlocked List 74 for the selected television signal input (e.g. source: Antenna A). The user must now decide whether a particular channel is appropriate to be included into the Unlocked List 74 (e.g. “Is this channel good enough to be viewed every time I press the channel buttons on the remote?” or “Is this channel something I want my child to watch?”) or the Locked List 70 (e.g. “When the TV is locked, do I want my child to be able to see this channel when my child uses the channel buttons on the remote?”). Setting up these lists is expedited if the user goes to an “All Channels” section 72 and makes the selection thereof.

Particularly, if the user looks at the toggle (“flip-flop”) button under the Locked List 72 and the button says “Blocked”, the channels are all blocked. If this is selected, then the button text will change to read “Viewable” and all of the channels will be set to viewable. If the user selected the toggle button under the Locked List 72 and the button says “Viewable” (all channels are set to viewable), then the button text will change to read “Blocked” and all the channels will be set to “Blocked”. FIG. 4B shows both Blocked and Viewable for illustrative purposes. The user can also configure the Unlocked List 76 by using an All Channels button 76 except that instead of the button reading “Blocked” or “Viewable”, the presence of a checkmark determines whether a channel is added or deleted from the Unblocked List. This may be done globally or individually. Of course, other schemes may be used for such global viewing state setting for the viewing lists and/or individual channel viewing state setting. Moreover, the All Channels may be a single button rather than two buttons. Various on-screen selection schemes may be utilized.

The various embodiments of the subject invention also are contemplated to, and preferably does include, an error prevention feature that prevents the user from wiping out all his/her previous viewing state settings, particularly the selecting and de-selecting of individual channels after a global setting. In one form, when a global view and/or global block is selected by the user, the error prevention feature provides an on-screen display of an alert panel or the like asking a question such as “Are you sure you want to make all channels in the Unlocked/Viewable (or Locked/Blocked) Blocked (or Viewable)?” The user can then select Yes or No. The user is then provided with the appropriate on-screen menus to continue as desired.

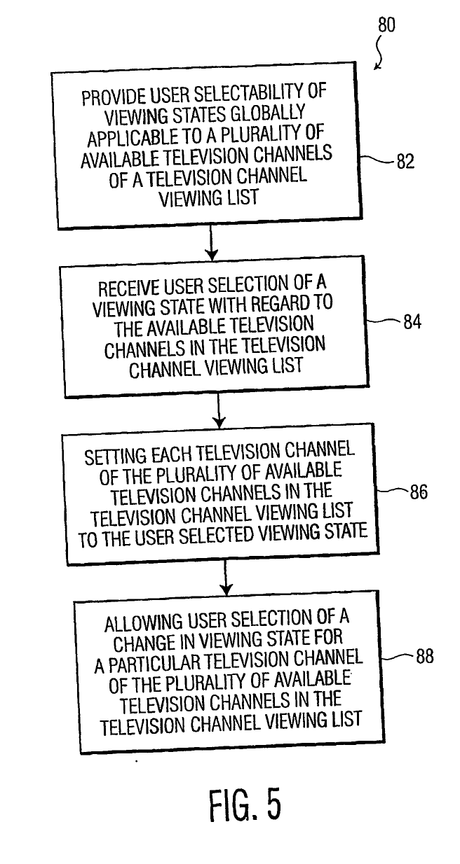

Referring now to FIG. 5, there is depicted a flowchart, generally designated 80, of an exemplary manner of operation of the television signal receiver 22 in accordance with the principles of the subject invention. In block 82, the television signal receiver 22 provides user selectability of viewing states globally applicable to a plurality of available television channels of a television channel viewing status or states list. This may be accomplished as provided by the channel viewing status or states list 44 of FIG. 3A and 3B. In block 84, the television signal receiver 22 receives user selection of a viewing state with regard to the available television channels in the television channel viewing list. As indicated above, this is either a view state or a blocked state.

In block 86, the television signal receiver 22 sets each television channel of the plurality of available television channels in the television channel viewing list to the user selected viewing state (i.e. globally sets all of the channels to the same selected viewing state). Thereafter, the television signal receiver 22 allows the user to select a change in viewing state for a particular television channel of the plurality of available television channels in the television channel viewing list. This last step may be repeated as necessary. Moreover, the user may start over again to globally set all of the channels to the same viewing state.

It should be appreciated that a method in accordance with the principles of the subject invention may contain more steps than described in conjunction with the flowchart 80 of FIG. 5 and/or different or modified steps than that described. As well, other manners of providing global setting of a viewing state with respect to a television channel viewing list are contemplated and expected.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims.

1. A method of setting up a television channel viewing list, comprising the steps of:
receiving user selection of a viewing state with regard to a television channel viewing list having a plurality of available television channels; and
setting each television channel of the plurality of available television channels in the television channel viewing list to the user selected viewing state.

2. The method of claim 1, wherein receiving user selection of a viewing state with regard to a television channel viewing list having a plurality of available television channels includes receiving user selection of a viewing state that is one of blocked and viewable.

3. The method of claim 1, wherein receiving user selection of a viewing state with regard to a television channel viewing list having a plurality of available television channels includes:
providing an on-screen television channel viewing list menu having user-selectable viewing states globally applicable to a plurality of available television channels of a television channel viewing list.

4. The method of claim 3, wherein providing an on-screen television channel viewing list menu having user-selectable viewing states globally applicable to a plurality of available television channels of a television channel viewing list includes:
providing an on-screen television channel viewing list menu having user-selectable viewing states globally applicable to a plurality of available television channels of a television channel viewing list for each one of a plurality of television signal inputs.

5. The method of claim 1, further comprising:
allowing user selection of a change in viewing state for a particular television channel of the plurality of available television channels in the television channel viewing list.

6. Television signal processing apparatus comprising:
a signal processor;
a user-input receiver in communication with said signal processor and operative to receive user input; and
memory in communication with said signal processor and storing program instructions which, when executed by said signal processor, causes the television signal processing apparatus to:
receive user selection of a viewing state with regard to a television channel viewing list having a plurality of available television channels; and
set each television channel of the plurality of available television channels in the television channel viewing list to the user selected viewing state.

7. The television signal processing apparatus of claim 6, wherein said memory stores further program instructions which, when executed by said signal processor, causes the television signal processing apparatus to:
receive user selection of a viewing state with regard to a television channel viewing list having a plurality of available television channels that is one of blocked and viewable.

8. The television signal processing apparatus of claim 6, further comprising:
an on-screen display generator in communication with said signal processor; and
wherein said memory stores further program instructions which, when executed by said signal processor, causes the television signal processing apparatus to:
provide an on-screen television channel viewing list menu having user-selectable viewing states globally applicable to a plurality of available television channels of a television channel viewing list.

9. The television signal processing apparatus of claim 8, wherein said memory stores further program instructions which, when executed by said signal processor, causes the television signal processing apparatus to:
provide an on-screen television channel viewing list menu having user-selectable viewing states globally applicable to a plurality of available television channels of a television channel viewing list for each one of a plurality of television signal inputs.

10. The television signal processing apparatus of claim 8, wherein said memory stores further program instructions which, when executed by said signal processor, causes the television signal processing apparatus to:
allow user selection of a change in viewing state for a particular television channel of the plurality of available television channels in the television channel viewing list.

11. A television signal processing system comprising:
a signal processor;
a user-input receiver in communication with said signal processor; and
memory (32) in communication with said signal processor and storing program instructions executable by said signal processor;
wherein said user-input receiver is operative to receive user selection of a viewing state with regard to a television channel viewing list having a plurality of available television channels; and
said signal processor is operative to set each television channel of the plurality of available television channels in the television channel viewing list to the user selected viewing state.

12. The television signal processing system of claim 11, wherein memory stores further program instructions which, when executed by said signal processor, causes the television signal processing system to:
receive user selection of a viewing state with regard to a television channel viewing list having a plurality of available television channels that is one of blocked and viewable.

13. The television signal processing system of claim 11, further comprising:
an on-screen display generator in communication with said signal processor and operative to provide an on-screen television channel viewing list menu having user-selectable viewing states globally applicable to a plurality of available television channels of a television channel viewing list to a display.

14. The television signal processing system of claim 13, wherein said on-screen display generator is further operative to provide an on-screen television channel viewing list menu having user-selectable viewing states globally applicable to a plurality of available television channels of a television channel viewing list for each one of a plurality of television signal inputs.

15. The television signal processing system of claim 11, wherein said memory stores further program instructions which, when executed by said signal processor, causes the television signal processing system to:
allow user selection of a change in viewing state for a particular television channel of the plurality of available television channels in the television channel viewing list.
